(19) United States
(12) Patent Application Publication
(10) Pub. No.: US 2006/0044465 A1
(43) Pub. Date: Mar. 2, 2006

(54) Simplified offset current reducting circuit for auto kine bias (akb)

(76) Inventor: Daniel Lee Reneau, Fishers, IN (US)

Correspondence Address: THOMSON LICENSING INC., PATENT OPERATIONS, PO BOX 5312, PRINCETON, NJ, 08543-5312, US

(21) Appl. No.: 10/524,257

(22) PCT Filed: Aug. 14, 2003
(86) PCT No.: PCT/US03/25647

§ 371 Date: Feb. 10, 2005

Related U.S. Application Data
(60) Provisional application No. 60/404,236, filed on Aug. 16, 2002.

(51) Int. Cl. H04N 5/68

(52) U.S. Cl. 348/379

(57) ABSTRACT

The disclosed embodiments relate to a current reduction circuit that reduces offset current from at least one driver circuit. The current reduction circuit comprises circuitry that measures the offset current and produces a measurement current and circuitry that receives the measurement current and responds by maintaining an auto kine bias measurement voltage within a predetermined range.

### FIELD OF THE INVENTION

This invention relates to the field of auto kine bias (AKB), and in particular, to an offset current reducing circuit for AKB

### BACKGROUND OF THE INVENTION

This section is intended to introduce the reader to various aspects of art which may be related to various aspects of the present invention which are described and/or claimed below. This discussion is believed to be helpful in providing the reader with background information to facilitate a better understanding of the various aspects of the present invention. Accordingly, it should be understood that these statements are to be read in this light, and not as admissions of prior art.

A cathode ray tube (CRT) driver integrated circuit, such as the Philips TDA6120 CRT driver integrated circuit, can be used as a CRT driver. The TDA6120 has a cathode current sample output pin that can be used for AKB. The design of the measurement circuit is such that there can be as much as +/−30 microamperes of offset current added to the desired CRT cathode measurement current for each of the red, green and blue drives. However, a back end signal and sync processor such as the Toshiba TA1316AN has an AKB sampling system with a limited dynamic range, and cannot handle the potential total of +/−90 microamperes of offset (3 X+/−30 μA). The AKB will not function under this condition. This invention is intended to remove enough of the offset current that the remainder is within the dynamic range of the measurement circuit of the TA1316AN. Data sheets of detailed operation for the TDA6120 and the TA1316AN are available from Philips and Toshiba respectively.

The invention represents an improvement over a concept used previously utilized in the manufacture of televisions. That concept, when modified for projection TV, required three current clamps, one on each of the red, green and blue CRT drive boards. While this arrangement works very well, it is complicated and has a large number of parts. Moreover, if any one of the three clamps malfunctions the AKB system will not operate correctly. This can cause the instrument to shut down. Accordingly, there is a need to simplify this design to provide the same performance, yet at the same time, to be more robust and be subject to fewer problems. Moreover, reducing the number of parts can significantly reduce the cost of production.

### SUMMARY OF THE INVENTION

The disclosed embodiments relate to a current reduction circuit that reduces offset current from at least one driver circuit. The current reduction circuit comprises circuitry that measures the offset current and produces a measurement current and circuitry that receives the measurement current and responds by maintaining an auto kine bias measurement voltage within a predetermined range.

### BRIEF DESCRIPTION OF THE DRAWINGS

In the drawings:

FIG. 1 is a circuit schematic for an offset current reducing circuit for AKB in accordance with the inventive arrangements.

### DETAILED DESCRIPTION OF THE PREFERRED EMBODIMENT

One or more specific embodiments of the present invention will be described below. In an effort to provide a concise description of these embodiments, not all features of an actual implementation are described in the specification. It should be appreciated that in the development of any such actual implementation, as in any engineering or design project, numerous implementation-specific decisions may be made to achieve the developers' specific goals, such as compliance with system-related and business-related constraints, which may vary from one implementation to another. Moreover, it should be appreciated that such a development effort might be complex and time consuming, but would nevertheless be a routine undertaking of design, fabrication, and manufacture for those of ordinary skill having the benefit of this disclosure.

In accordance with the inventive arrangements, a single comparator can be utilized instead of the three current clamps used by the previous system. More particularly, and in the presently preferred embodiment, the comparator is responsive to a voltage derived from the sampled beam current and a reference voltage. The comparator output is a current substantially free of the influences of offset current, and therefore, assured of remaining within a predetermined dynamic range. The inventive arrangements reduce the offset current from the CRT driver IC sufficiently to allow a back end signal and sync processor's AKB measurement circuit, even one subject to a limited dynamic range, to operate correctly. The inventive arrangements substantially remove both positive and negative offset currents. As compared to the previously described current clamp system, the total part count is advantageously reduced by approximately 85 components. Other advantages of the inventive arrangements may be applicable to other kinds of circuits.

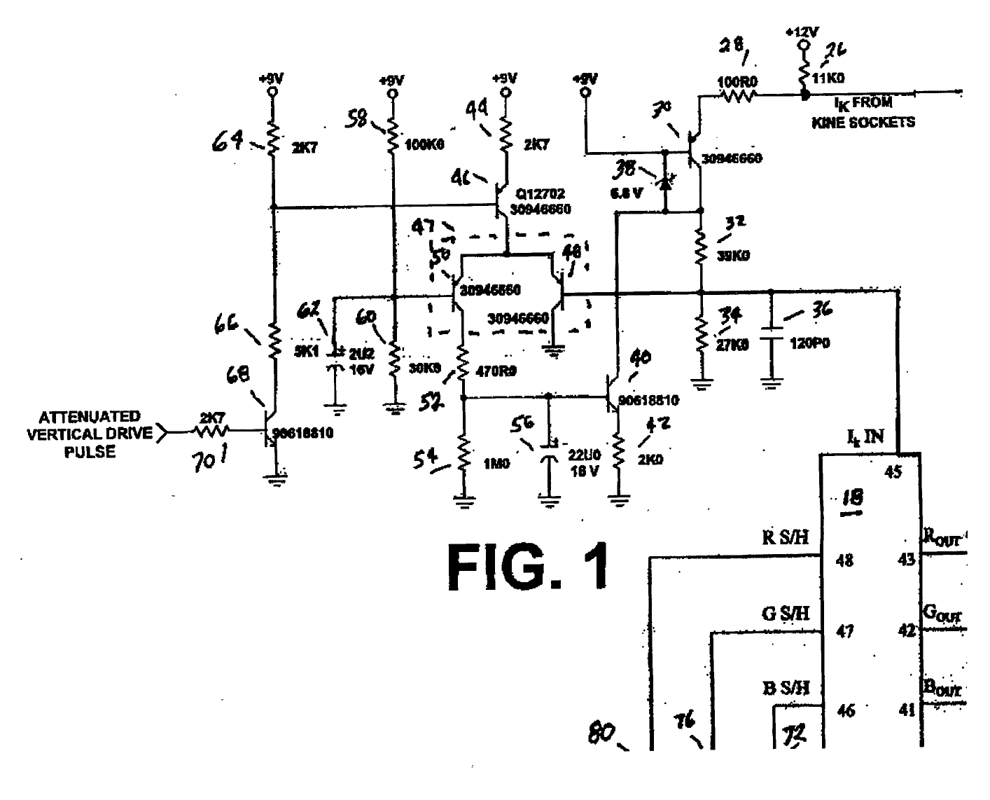

With reference to FIG. 1, an offset current reducing circuit 10 is illustrated. The kine current measurement outputs from pin 7 of each of three TDA6120 CRT driver ICs 12, 14 and 16 (one each for red, green and blue) are coupled to the node labeled “I_{K} FROM KINE SOCKETS”. Each of the kine current measurement outputs from the CRT drivers 12, 14 and 16 has a series resistor (20, 22 and 24, respectively) coupled thereto to provide arc protection. An 11 K ohm resistor 26 is also coupled to the node and is returned to a +12 volt power supply. The AKB circuit is completed by the red, green and blue, low-level drive signals that are output from integrated circuit 18 pins 43,42 and 41, respectively, being applied to the input pin 2 of respective CRT driver integrated circuits 12, 14 and 16. The basic operation of the AKB circuit is for the DC bias of low-level red, green and blue drive signals to be controlled by the voltage applied to pin 45 of integrated circuit 18 during each channel's measurement interval, thus controlling the bias applied to the red, green and blue cathodes 82, 78 and 74, respectively. The cathode current measurement signal at pin 7 of each CRT driver is reflective of the cut-off bias of each cathode connected to pin 12 of that CRT driver. The error correction signal for each channel of the AKB control loop is held on capacitors 80, 76 and 72, which are connected to the red, green and blue filter pins 48, 47 and 46 of integrated circuit 18. The time constant associated with each channel's dominant pole is determined by the value of capacitors 80, 76 and 72 and is typically on the order of several fields, the specific value being chosen for loop stability and noise performance. The dominant pole of the offset current reduction circuit is formed by the values of capacitor 56 and resistor 54. The charge rate of capacitor 56 is determined by resistor 54 and the value of transistor 50 collector current, while the discharge rate is determined by resistor 54. The time constant of the dominant pole of the offset current reduction circuit must be much longer than the dominant pole time constant of the AKB loop. In the preferred embodiment the offset current reduction circuit time constant is several seconds and the power-on charge is set to stabilize the loop in about four seconds in order to avoid a visible brightness “bounce” when power is applied. Those of ordinary skill in the art will appreciate that the values of components, component identification numbers, voltage levels and the like referred to herein and in FIG. 1 are exemplary only. Other values may be used in some cases as a matter of design choice.

A 5V peak-to-peak pulse signal (0V to 5V) whose width is approximately 64 microseconds and whose repetition rate is approximately 16.7 milliseconds is coupled to a resistor 70. This pulse is an attenuated version of the vertical drive pulse. The pulse occurs shortly after the start of the vertical blanking interval. At this time, the total CRT beam current is theoretically zero. As a practical matter, there is a small amount of flyback signal pickup, but it is small enough to be neglected. The pulse saturates a transistor 68, which develops a voltage of nominally 5.88 volts at the base of a transistor 46. This turns on a transistor 46, whose collector current is approximately 900 microamperes. The transistor 68 is connected to a voltage source as illustrated in FIG. 1 through a resistor 64 and a resistor 66. The collector current of the transistor 46 activates a differential amplifier 47 made up of a transistor 50 and a transistor 48. The base of transistor 50 is biased by the divider made up of resistors 58 and 60. This voltage divider establishes a base voltage of approximately 2.1 volts. The base of the transistor 50 is additionally coupled to ground via a capacitor 62. The collector of the transistor 50 is connected to ground via a resistor 52 and a resistor 54. The base of transistor 48 is connected to resistors 34 and 32, capacitor 36, and pin 45 of a Toshiba TA1316AN integrated circuit 18. Pin 45 of integrated circuit 18 is the AKB measurement point. The differential pair measures the difference between the divider voltage at the base of transistor 50 and the voltage resulting from the sum of the CRT cathode currents, the offset currents from the CRT driver ICs, the current provided by the 11 K ohm resistor 26 and the collector current of transistor 40. The offset current component must be substantially removed for AKB to function properly.

If the “zero current” voltage at pin 45 of the TA1316AN 18 at the time of the vertical rate pulse can be held between −0.5 volts and 3 volts, an internal clamp in the TA1316AN 18 can substantially reduce the remainder of the offset. However, the total voltage offset could theoretically be between −2.43 volts (−90 microamperes×27 K ohms) and +2.43 V (+90 microamperes×27 K ohms). One could, for example, simply pump approximately 70 microamperes of current into the node, and that would raise the minimum to −0.5 volts. However, the maximum would then become 4.36 volts, and this value is outside the dynamic range of the measurement system. If, however, the voltage at pin 45 can be maintained at approximately 2 volts, the system will function properly.

If the voltage at the base of transistor 48 is lower than the voltage at the base of transistor 50, indicating a negative offset current, the collector current of transistor 50 will be reduced, and the voltage on capacitor 56 and the base of transistor 40 will fall. This will reduce the collector current of transistor 40. The current of transistor 40 is subtracted from the sum of the “zero beam” current during the vertical pulse measurement period, the offset current, and the current that flows through the 11 K ohm resistor 26. Because the current in transistor 40 is reduced, the current through resistors 32 and 34 increases, and the voltage at pin 45 of the TA1316AN 18, which was low initially, increases.

Conversely, if the voltage at the base of transistor 48 is higher than the voltage at the base of transistor 50, indicating a positive offset current, the current in transistor 50 will increase, which will raise the voltage on the base of transistor 40. This increases the current in transistor 40, which reduces the current through resistors 32 and 34, dropping the voltage at pin 45 of the TA1316AN 18. The 11 K ohm resistor 26 advantageously adds an offset in the total current so that transistor 40 is always active over the total range of offset currents from the CRT driver ICs.

In an AKB system it is desirable to limit the voltage at the measurement point that results from high cathode currents that can occur during active video, since the cathode current always flows in the system, including negative first derivative currents resulting from discharging the parasitic cathode capacitances. This limiting of the measurement point voltage is advantageously accomplished in this system by passing the current through resistor 32 as well as resistor 34. As the sum of the cathode currents increases, the drop across these two resistors will eventually saturate transistor 30, the collector of which is connected to the node labeled “I_{K} FROM KINE SOCKETS” by a resistor 28. The voltage drop across the resistors 32 and 34 limits the voltage on pin 45 of the TA1316AN 18 to approximately 4 volts, and eliminates the need for a Zener diode or PNP emitter follower to clip the measurement voltage during active scan. A capacitor 36 is connected from integrated circuit 18 pin 45 to ground to filter any residual video rate signals at pin 45.

Development of the circuit resulted in several advantageous circuit component configurations and value selections that were not apparent in the initial design stage. The original value of resistor 44 was 5.6 K ohms. This value was reduced to 2.7 K ohms to improve the transient response of the clamp. Resistor 32 was originally 1 K ohm, but this value made the saturated collector voltage of transistor 30 too high and somewhat unpredictable. A value of 39 K ohm for resistor 32 provides a lower, more stable saturated collector voltage.

The Zener diode 38 was not originally in the system, but was added when it became apparent that the negative currents associated with the crosshatch pattern (discharging the parasitic cathode capacitances) caused the voltage at pin 45 of the TA1316AN 18 to try to go below ground. However, the base to collector junction of transistor 40 became forward biased before the voltage could get to ground via a resistor 42. This would start discharging capacitor 56 and cause the displayed picture to go green because of dynamic range limitation of the AKB measurement system. During active scan with a 100 IRE crosshatch pattern, the lower voltage at the base of transistor 40 would decrease its collector current, which resulted in higher current in resistor 34, thus raising the voltage at pin 45 of the TA1316AN 18. The clamp was not fast enough to restore the charge on the capacitor, and the voltage remained below the normal equilibrium point. With this condition, the green AKB pulse would start to go beyond the linear range of the AKB detector, and the system would increase the green video's bias level to compensate. This caused the green shift observed. With a Zener diode 38 installed, the collector of transistor 40 is advantageously always at or above 2.2V. This is sufficiently high to keep the base collector junction from becoming forward biased. It also advantageously allows the integrated circuit 18 pin 45 voltage to operate at the desired 2 volts DC since the level at pin 45 of the TA1316AN resulting from a voltage at the collector of transistor 40 of 2.2 volts is 0.9V. This means that the Zener is advantageously off when the AKB current measurement is made.

While the invention may be susceptible to various modifications and alternative forms, specific embodiments have been shown by way of example in the drawings and will be described in detail herein. However, it should be understood that the invention is not intended to be limited to the particular forms disclosed. Rather, the invention is to cover all modifications, equivalents and alternatives falling within the spirit and scope of the invention as defined by the following appended claims.

1. A current reduction circuit that reduces offset current from at least one driver circuit, the current reduction circuit comprising:
circuitry that measures the offset current and produces a measurement current; and
circuitry that receives the measurement current and responds by maintaining an auto kine bias measurement voltage within a predetermined range.

2. The current reduction circuit set forth in claim 1, wherein the at least one driver circuit comprises three cathode ray tube (CRT) driver circuits, each of the CRT driver circuits corresponding to a color beam in a CRT display device.

3. The current reduction circuit set forth in claim 2, wherein each of the CRT driver circuits comprises a Philips TDA6120 CRT drive integrated circuit.

4. The current reduction circuit set forth in claim 1, wherein the auto kine bias measurement voltage is provided to a Toshiba TA1316AN integrated circuit.

5. The current reduction circuit set forth in claim 4, wherein the auto kine bias measurement voltage corresponds to an offset current that is within the dynamic range that may be processed by the Toshiba TA1316AN integrated circuit.

6. The current reduction circuit set forth in claim 1, wherein the predetermined range is between about −0.5 volts and 3.0 volts.

7. The current reduction circuit set forth in claim 1, wherein the circuitry that measures the offset current comprises a circuit that generates a reference voltage that is compared to a signal corresponding to the offset current to generate the measurement current.

8. The current reduction circuit set forth in claim 1, wherein the current reduction circuit comprises a portion of a television.

9. The current reduction circuit set forth in claim 1, wherein the offset current has a maximum range of about +/−90 microamperes.

10. A cathode ray tube (CRT) display device that is adapted to display images, comprising:
a CRT;
three driver circuits, each of the driver circuits being associated with a color beam adapted to create an image on the CRT, each of the three driver circuits producing a signal indicative of an offset current;
a circuit that generates a reference voltage;
a differential amplifier that receives the reference voltage and the signal indicative of the offset current from the three driver circuits and responds by producing a differential output that is proportional to the difference between the reference voltage and the signal corresponding to the offset current from the three driver circuits; and
circuitry that receives the differential output and responds by maintaining an auto kine bias measurement voltage within a predetermined range.

11. The CRT display device set forth in claim 10, wherein each of the driver circuits comprises a Philips TDA6120 CRT drive integrated circuit.

12. The CRT display device set forth in claim 10, wherein the auto kine bias measurement voltage is provided to a Toshiba TA1316AN integrated circuit.

13. The CRT display device set forth in claim 12, wherein the auto kine bias measurement voltage corresponds to an offset current that is within the dynamic range that may be processed by the Toshiba TA1316AN integrated circuit.

14. The CRT display device set forth in claim 10, wherein the predetermined range is between about −0.5 volts and 3.0 volts.

15. The CRT display device set forth in claim 10, wherein the CRT display device comprises a portion of a television.

16. The CRT display device set forth in claim 10, wherein the offset current from the three driver circuits has a total maximum range of about +/−90 microamperes.

17. A method of reducing offset current from at least one driver circuit, the method comprising:
measuring an offset current associated with the at least one driver circuit;
producing a measurement current in response to the measurement of the offset current;
employing the measurement current to maintain an auto kine bias measurement voltage within a predetermined range.

18. The method of reducing offset current set forth in claim 17, comprising generating a reference voltage.

19. The method of reducing offset current set forth in claim 18, comprising comparing the reference voltage to a signal proportional to the offset current.

20. The method of reducing offset current set forth in claim 17, wherein the recited acts are performed in the recited order.
